(19) United States
(12) Patent Application Publication
(10) Pub. No.: US 2012/0091068 A1
(43) Pub. Date: Apr. 19, 2012

(54) METHOD FOR PHOTOCATALYTIC WATER PURIFICATION

(75) Inventors: Florina Corina Patcas, Ludwigshafen (DE); Grigorios Kolios, Neustadt (DE); Götz-Peter Schindler, Ludwigshafen (DE); Peter Pfab, Neustadt (DE); Reinhard Hess, Ellerstadt (DE)

(73) Assignee: BASF SE, Ludwigshafen (DE)

(21) Appl. No.: 13/378,100

(22) PCT Filed: Jun. 23, 2010
(86) PCT No.: PCT/EP2010/058869

§ 371 Date: Dec. 14, 2011

(30) Foreign Application Priority Data
Jun. 24, 2009 (EP) 09163385.4

(51) Int. Cl. C02F 1/32

(52) U.S. Cl. 210/748.14

(57) ABSTRACT

The present invention relates to a process for the purification of a contaminant-containing stream by bringing the stream to be purified into contact with a heterogeneous photocatalyst with irradiation with light, where the bringing into contact takes place in the presence of at least one compound dissolved in the stream and comprising at least one metal selected from the group consisting of iron, chromium, nickel, cobalt, manganese and mixtures thereof, and to the use of a heterogeneous photocatalyst for the purification of a contaminant-containing stream, where, in the stream to be purified, at least one compound comprising at least one metal selected from the group consisting of iron, chromium, nickel, cobalt, manganese and mixtures thereof is present in dissolved form.

The present invention relates to a process for the purification of a contaminant-containing stream by bringing the stream to be purified into contact with a heterogeneous photocatalyst with irradiation with light, where the bringing into contact takes place in the presence of at least one compound dissolved in the stream to be purified and comprising at least one metal selected from the group consisting of iron, chromium, nickel, cobalt, manganese and mixtures thereof, and to the use of a heterogeneous photocatalyst for the purification of a contaminant-containing stream, where, in the stream to be purified, at least one such compound is present in dissolved form.

Processes for the purification of wastewater and the use of photocatalysts, in particular of TiO₂ photocatalysts, are already known from the prior art.

Paola et al., Applied Catalysis B: Environmental 48 (2204), 223-233, discloses that TiO₂ photocatalysts which are doped with various metal cations, for example Fe²⁺ cations, catalyze the oxidative degradation of organic acids. This publication does not disclose that polyvalent metal cations can be added in dissolved form to the wastewater.

Choi et al., J. Phys. Chem. 1994, 98, 13669-13679, disclose that titanium dioxide doped with metal cations such as Fe³⁺, Mo⁵⁺, Ru³⁺ etc. can be used as photocatalyst.

Wang et al., J. of Photochemistry and Photobiology A: Chemistry 198 (2008) 282-287 and P. Sawunyama, Materials Research Bulletin, Vol. 33, No. 5, pp. 795-801, 1998, likewise mention titanium dioxide photocatalysts doped with Fe²⁺ and improved processes for their preparation.

Mills et al., J. of Photochemistry and Photobiology A: Chemistry 108 (1997) 1-35, disclose inter alia the use of a combination of solid titanium dioxide and dissolved Fe³⁺ cations for the oxidation of water molecules.

The prior art does not disclose a process for the purification of wastewater in which a combination of a heterogeneous photocatalyst and dissolved metal compounds, in particular in especially small amounts, is used.

It is an object of the present invention to provide a process for the purification of a contaminant-containing stream which is notable for particularly high efficiency, for example the process according to the invention should have a consistently high purifying effect even over a prolonged period. Furthermore, the process should effectively separate off the contaminating substances present in the stream to be purified to give a purified stream which has an especially low content of contaminants. The process according to the invention should be notable for simple and cost-effective process management, for example only small amounts of metal cations should be used.

These objects are achieved according to the invention by a process for the purification of a contaminant-containing stream by bringing the stream to be purified into contact with a heterogeneous photocatalyst with irradiation with light, where the bringing into contact takes place in the presence of at least one compound dissolved in the stream to be purified and comprising at least one metal selected from the group consisting of iron, chromium, nickel, cobalt, manganese and mixtures thereof.

Furthermore, the objects are achieved according to the invention through the use of a heterogeneous photocatalyst for the purification of a contaminant-containing stream, where, in the stream to be purified, at least one compound comprising at least one metal selected from the group consisting of iron, chromium, nickel, cobalt, manganese and mixtures thereof is present in dissolved form.

In general, in the process according to the invention, all photocatalysts known to the person skilled in the art can be used, for example selected from the group consisting of titanium dioxide (TiO₂), tungsten oxide (WO₃), zinc oxide and mixtures thereof.

Consequently, in one preferred embodiment, the present invention relates to the process according to the invention where a photocatalyst selected from the group consisting of titanium dioxide, tungsten oxide (WO₃), zinc oxide and mixtures thereof is used.

In one preferred embodiment of the process according to the invention, titanium dioxide is used as heterogeneous photocatalyst.

In one particularly preferred embodiment, titanium dioxide is used which is essentially present in the anatase modification. Within the context of the present invention, “essentially” means that at least 50%, particularly preferably at least 75%, of the titanium dioxide is present in the anatase modification, based on the XRD measurement method known to the person skilled in the art. The remainder of the titanium dioxide consists of amorphous metal oxide, the brookite modification or rutile modification of titanium dioxide or a mixture thereof. In a very particular preferred embodiment, the titanium dioxide used is present entirely, i.e. determined by XRD as 100%, in the anatase modification.

The TiO₂ photocatalyst which can be used according to the invention generally has a BET surface area of from 25 to 200 m²/g, preferably 50 to 180 m²/g, particularly preferably 80 to 150 m²/g. The BET surface area can be determined by methods known to the person skilled in the art, for example in accordance with DIN 66 131.

The TiO₂ photocatalyst which can be used according to the invention generally has a pore volume of from 0.1 to 1.00 ml/g, preferably 0.2 to 0.7 ml/g, particularly preferably 0.25 to 0.75 ml/g. The pore volume can be determined by methods known to the person skilled in the art.

The TiO₂ photocatalyst which can be used according to the invention generally has an average pore diameter of from 0.001 to 0.050 μm, preferably 0.005 to 0.030 μm, particularly preferably 0.010 to 0.025 μm. The average pore diameter can be determined by methods known to the person skilled in the art.

As photocatalytically active materials, the TiO₂ photocatalyst used comprises essentially titanium dioxide, i.e. the photocatalyst used comprises generally at least 90% by weight, preferably at least 95% by weight, particularly preferably 99%, of titanium dioxide. The remainder are inorganic or organic additives, or a mixture thereof.

In general, the heterogeneous photocatalyst may be present in any geometry known to the person skilled in the art, for example as strands, tablets, honeycomb lattice structures, powders, nanoparticles, coatings or combinations thereof.

In one particularly preferred embodiment, a strand-shaped photocatalyst, especially preferably a strand-shaped TiO₂ photocatalyst, is used.

Within the context of the present invention, strand-shaped means that the photocatalyst used preferably has an oval or round base. The diameter of this round base or of an oval base in the largest expansion is generally 0.2 to 10 mm, preferably 0.5 to 3.0 mm. The strand-shaped photocatalyst generally has a length of from 0.5 to 10 mm, preferably 0.8 to 8 mm, particularly preferably 1.0 to 5.0 mm. The ratio of length to diameter of the strand-shaped photocatalyst used according to the invention is generally 0.05 to 50, preferably 1.0 to 10.

In a further preferred embodiment, the TiO₂ photocatalyst, particularly preferably the strand-shaped TiO₂ photocatalyst, comprises at least one additive, particularly preferably selected from groups 1, 4, 8, 9, 10, 11, 13, 14, 15 of the Periodic Table of the Elements (new IUPAC nomenclature) or the lanthanoids, for example selected from the group consisting of sodium, potassium, zirconium, cobalt, zinc, iron, copper, silver, gold, palladium, platinum, gallium, nitrogen, carbon, sulfur, ytterbium, erbium, thulium, neodym and mixtures thereof, in elemental or in oxidic form. Preferably, combinations of two or more of these specified additives may also be present, particularly preferred combinations are zirconium and nitrogen, zirconium and cobalt, lanthanum and zirconium, potassium and zirconium or sodium and zirconium.

The at least one additive is present in the TiO₂ photocatalyst used according to the invention preferably in an amount of from 0.001 to 5% by weight, particularly preferably 0.01 to 3% by weight. If two or more of the specified additives are present simultaneously in the TiO₂ photocatalyst used according to the invention, then the stated quantitative data refers to this mixture.

The strand-shaped TiO₂ photocatalyst particularly preferably used according to the invention can be prepared by all processes known to the person skilled in the art. In one preferred embodiment, the strand-shaped TiO₂ photocatalyst used according to the invention is obtained by mixing the corresponding amounts of titanium dioxide and at least one organic binder, preferably selected from sugar derivatives, for example Tylose, starch solutions, for example food starches, celluloses such as, for example, methylcellulose and/or at least one fatty acid, for example stearic acid, polymers such as, for example, polyethylene oxide and at least one acid, for example a mineral acid such as dilute nitric acid or hydrochloric acid or an organic acid such as formic acid. This mixture is mixed, for example milled, by methods known to the person skilled in the art in customary devices. The resulting mixture can then be extruded to give the corresponding strand-shaped TiO₂ photocatalyst. The extrudate produced in this way is preferably dried at a temperature of at most 120° C., and the resulting strands are then preferably calcined at a temperature of from 300 to 500° C. in an air atmosphere in order to obtain the preferred combination of BET surface area, pore volume and average pore diameter.

Particularly the use of Tylose and stearic acid in the production of the TiO₂ strands preferably used according to the invention leads to the resulting titanium dioxide having the combination according to the invention of high activity and high stability with lasting high activity over a long period.

In a further preferred embodiment, the photocatalyst is applied as coating to a support of any desired shape, through or over which the liquid to be purified flows. Examples of supports which may be used are rings, beads, cylinders, perforated plates, woven fabrics, nets, honeycombs, sponges made of metal, ceramic, glass or plastic. The support can be coated with the photocatalytically active mass using any method known to the person skilled in the art, such as e.g. dip drawing, spraying, rotary drawing etc.

In a further embodiment, the photocatalyst can be used as powder in the steam to be purified, such that it forms a suspension with the stream, preferably with water.

In the process according to the invention, the at least one heterogeneous photocatalyst, in particular the TiO₂ photocatalyst, is generally used in an amount which ensures that the process according to the invention can be carried out with sufficiently high purification capability.

The process according to the invention takes place by bringing the stream to be purified into contact with a heterogeneous photocatalyst with irradiation with light, where the bringing into contact takes place in the presence of at least one compound dissolved in the stream to be purified and comprising at least one metal selected from the group consisting of iron, chromium, nickel, cobalt, manganese and mixtures thereof.

In general, according to the invention, it is possible to use all compounds of the stated metals which have sufficiently great solubility in the stream to be purified.

Suitable compounds comprising iron are selected, for example, from the group consisting of iron(II) compounds, such as Fe(NO₃)₂, FeSO₄, iron(II) halides, for example FeCl₂, FeBr₂, iron(III) compounds such as Fe(NO₃)₃, Fe₂(SO₄)₃, iron(III) halides, for example FeCl₃, FeBr₃ and mixtures thereof.

In a very particularly preferred embodiment, FeCl₂ and/or FeCl₃, particularly preferably FeCl₂, is used. Instead of the specified Fe compounds, it is also possible to analogously use the corresponding hydrated salts, such as Fe(NO₃)₃.9 H₂O, FeCl₃.6 H₂O, FeCl₂.4 H₂O.

The present invention relates in particular to the process according to the invention where the at least one compound dissolved in the stream to be purified is iron(II) chloride, iron(III) chloride or a mixture thereof.

Suitable compounds comprising chromium are selected, for example, from the group consisting of chromium(III) compounds, such as chromium nitrate Cr(NO₃)₃, chromium(III) halides, for example CrCl₃, CrBr₃, and mixtures thereof. Instead of the specified Cr compounds, it is also possible to analogously use the corresponding hydrated salts, for example Cr(NO₃)₃.9 H₂O, CrCl₃.6 H₂O.

Suitable compounds comprising nickel are selected, for example, from the group consisting of nickel(II) compounds, such as NiSO₄, Ni(NO₃)₂, NiCl₂, and also the corresponding hydrated salts, such as NiSO₄.6 H₂O, Ni(NO₃)₂.6 H₂O, NiCl₂.H₂O.

Suitable compounds comprising cobalt are selected, for example, from the group consisting of cobalt(II) compounds, such as Co(NO₃)₂, CoSO₄, CoCl₂, and also the corresponding hydrated salts, such as Co(NO₃)₂.6 H₂O, CoSO₄.7 H₂O, CoCl₂.6 H₂O.

Suitable compounds comprising manganese are selected, for example, from Mn(II) compounds, such as Mn(NO₃)₂, MnSO₄, MnCl₂, Mn(VII) compounds, such as KMnO₄, and also the corresponding hydrated salts, such as Mn(NO₃)₂.4 H₂O, MnSO₄.H₂O, MnCl₂.4 H₂O.

In general, the at least one dissolved compound in the stream to be purified is added to the stream in an amount which permits an adequately high purifying effect by the process according to the invention.

In one preferred embodiment of the process according to the invention, the at least one compound dissolved in the stream and comprising at least one metal selected from the group consisting of iron, chromium, nickel, cobalt, manganese and mixtures thereof is present in an amount of from 10 to 1000 ppm, preferably 10 to 500 ppm, particularly preferably 10 to 300 ppm, in each case based on the sum of stream to be purified and the at least one compound dissolved in the stream.

The process according to the invention can be carried out at an acidic, neutral or basic pH. In one preferred embodiment, the process according to the invention is carried out at an acidic pH, for example pH 1 to pH 5. According to the invention, it is possible for the stream to be purified to automatically have the correct pH, or for it to be adjusted by adding a corresponding amount of acid or base.

In one preferred embodiment, the process according to the invention is carried out in the absence of an oxidizing agent, for example hydrogen peroxide, oxygen and/or ozone. Within the concept of the present invention, “in the absence of an oxidizing agent, for example hydrogen peroxide, oxygen and/or ozone” means that the specified compounds are present in an amount below the analytical detection limit. Suitable analysis methods are known to the person skilled in the art.

In a further preferred embodiment of the process according to the invention, oxygen and/or air is added as oxidizing agent to the stream to be purified.

One advantage of the process according to the invention is that it can be carried out without adding the expensive oxidizing agents known from processes from the prior art, such as hydrogen peroxide (Fenton process) or ozone.

Using the process according to the invention, it is possible to purify streams in which troublesome or toxic substances are present. According to the invention, the stream to be purified is preferably a liquid stream, particularly preferably a stream based on water, for example wastewater or drinking water.

Consequently, in one preferred embodiment, the present invention relates to the process according to the invention where the stream to be purified is a liquid stream.

Through the process according to the invention, the stream, in particular the water-based stream, is purified, i.e. after the process, the concentration of troublesome substances is lower than that before carrying out the process according to the invention.

Within the context of the present invention, the wastewater to be purified according to the invention can be, for example, from industrial plants, for example oil refineries, paper factories, mines, in the food sector or in the chemical industry, the private sector, for example sports grounds, restaurants, hospitals, or it may be of natural origin.

In general, the troublesome substances which are to be removed from the stream, in particular from wastewater or drinking water, are selected from organic or inorganic substances which, were they to remain in the stream to be purified, would develop a troublesome effect, for example through a toxic effect, odor nuisance, coloration of the stream, etc.

Preferably, the substances which can be removed from the stream to be purified by the process according to the invention are selected from organic compounds selected from the group consisting of organic acids, halogenated organic substances, aromatic or aliphatic organic substances, amines, oligomeric or polymeric materials, alcohols, ethers, esters, sugars, biodegradable or nonbiodegradable substances, surfactants and mixtures thereof.

The substances which are to be removed from the stream to be purified by the process according to the invention are generally present in amounts customary for the industrial or private sector, for example from 1 ppb to 1000 ppm, preferably from 1 ppm to 100 ppm.

The process according to the invention is generally carried out in order to reduce the contaminant content in the stream to be purified. Consequently, the substances which are removed from the stream by the process according to the invention are preferably present in a lesser amount after carrying out the process according to the invention in the stream to be purified than before the process according to the invention.

The process according to the invention for the purification of a stream is carried out by bringing the stream to be purified into contact with a heterogeneous photocatalyst with irradiation with light, where the bringing into contact takes place in the presence of at least one compound dissolved in the stream and comprising at least one metal selected from the group consisting of iron, chromium, nickel, cobalt, manganese and mixtures thereof. Suitable compounds are specified above.

This bringing into contact can be carried out continuously or discontinuously. Suitable devices are known to the person skilled in the art, for example fixed bed reactors such as flow tubes or plate reactors.

In one preferred embodiment, the heterogeneous photocatalyst, in particular a strand-shaped TiO₂ photocatalyst, is introduced into an appropriate vessel, for example a flow tube, and the stream to be purified is passed over and/or through this catalyst. The flow rate of the flow to be purified is adjusted here such that there is a sufficiently long contact time between the flow to be purified and the photocatalyst. A suitable flow rate is, for example, 0.001 to 100 cm/s, preferably 0.01 to 1 cm/s.

According to the invention, the at least one compound dissolved in the stream to be purified can be added to the stream before bringing it into contact with the TiO₂ photocatalyst. According to the invention, it is also possible for the addition to take place upon contacting.

In one preferred embodiment of the process according to the invention, this at least one compound is added to the stream to be purified before bringing it into contact with the heterogeneous photocatalyst.

One advantage of the process according to the invention is that the photocatalyst used cannot lose its activity by an optionally present doping element being leached out in the course of the process, as occurs in the processes of the prior art. According to the invention, therefore, a sufficiently large amount of dissolved compound is already present. Since this compound is present in homogeneously dissolved form, it is sufficient, on account of the increased activity associated therewith, to use only small amounts of these compounds.

A further advantage of the process according to the invention is furthermore that the soluble metal compound used is used in an extremely low, controlled concentration which, for example for the disposal of wastewater, does not constitute a hazard from the point of view of environmental protection.

The process according to the invention is carried out preferably at a temperature of from 4 to 80° C., particularly preferably 10 to 60° C., very particularly preferably 15 to 35° C. The process according to the invention is carried out generally at a pressure of from 0.5 to 50 bar, preferably 0.8 to 5 bar, particularly preferably at atmospheric pressure.

The process according to the invention comprises bringing the stream to be purified into contact with a heterogeneous photocatalyst in the presence of the specified dissolved compounds with irradiation with light.

According to the invention, any type of light known to the person skilled in the art can be used, for example light with a wavelength λ of from 150 to 800 nm, preferably 200 to 500 nm, very particularly preferably 360 to 420 nm. According to the invention, it is, for example, possible for the process according to the invention to be carried out with UV light (λ=150 to 400 nm), daylight (λ=380 to 800 nm) and/or the light of a standard commercial incandescent lamp (λ=400 to 800 nm).

The light intensity with which the irradiation with light takes place is generally 0.01 to 1000 mW/cm², preferably 0.1 to 100 mW/cm².

The present invention also relates to the use of a heterogeneous photocatalyst for the purification of a contaminant-containing stream, where, in the stream to be purified, at least one compound comprising at least one metal selected from the group consisting of iron, chromium, nickel, cobalt, manganese and mixtures thereof is present in dissolved form. In one preferred embodiment, the heterogeneous photocatalyst is titanium dioxide.

As regards the purification, the photocatalyst, the dissolved compounds and the further components and preferred embodiment, that stated with regard to the process according to the invention is applicable.

In particular, the at least one compound dissolved in the stream to be purified and comprising at least one metal selected from the group consisting of iron, chromium, nickel, cobalt, manganese and mixtures thereof is present in an amount of from 10 to 1000 ppm, preferably 10 to 500 ppm, particularly preferably 10 to 300 ppm, in each case based on the sum of stream to be purified and the at least one compound dissolved in the stream.

In one preferred embodiment, the present invention relates to the use according to the invention, where the at least one compound dissolved in the stream to be purified and comprising at least one metal selected from the group consisting of iron, chromium, nickel, cobalt, manganese and mixtures thereof is present in an amount of from 10 to 1000 ppm, preferably 10 to 500 ppm, particularly preferably 10 to 300 ppm, in each case based on the sum of stream to be purified and the at least one compound dissolved in the stream.

### EXAMPLES

### Comparative Example 1

5 l of wastewater comprising 44 ppm (parts by weight) of isobutyl chloride with a pH of 2 are pumped through a fixed-bed reactor filled with TiO₂ strands. The reactor comprises 100 g of catalyst and is irradiated with an 18 W black light lamp (λ=365 nm). After 24 h, 15.91% of the original amount of isobutyl chloride has degraded, and after 48 h 27.27% of the original amount of isobutyl chloride has degraded.

### Example 2

5 l of wastewater comprising 46 ppm (parts by weight) of isobutyl chloride with a pH of 2 are pumped through a fixed-bed reactor filled with TiO₂ strands. 300 ppm of Fe as FeCl₂ (iron(II) chloride) are added to the wastewater. The reactor comprises 100 g of catalyst and is irradiated with an 18 W black light lamp (λ=365 nm). After 24 h, 58.69% of the original amount of isobutyl chloride has degraded, and after 48 h 71.74% of the original amount of isobutyl chloride has degraded.

### Example 3

5 l of wastewater comprising 46 ppm (parts by weight) of isobutyl chloride with a pH of 2 are pumped through a fixed-bed reactor filled with TiO₂ strands. 15 ppm of Fe as FeCl₂ (iron(II) chloride) are added to the wastewater. The reactor comprises 100 g of catalyst and is irradiated with an 18 W black light lamp (λ=365 nm). After 24 h, 70.73% of the original amount of isobutyl chloride has degraded, and after 48 h 93.41% of the original amount of isobutyl chloride has degraded.

### Comparative Example 4

5 l of wastewater comprising 88 ppm (parts by weight) of isobutyl chloride with a pH of 2 are pumped through a fixed-bed reactor filled with TiO₂ strands. The reactor comprises 100 g of catalyst and is irradiated with an 18 W black light lamp (λ=365 nm). After 6 h, 7.95% of the original amount of isobutyl chloride has degraded, and after 24 h 19.32% of the original amount of isobutyl chloride has degraded.

### Example 5

5 l of wastewater comprising 100 ppm (parts by weight) of isobutyl chloride with a pH of 2 are pumped through a fixed-bed reactor filled with TiO₂ strands. 30 ppm of Fe as FeCl₂, 30 ppm of chromium as CrCl₃ and 30 ppm of nickel as NiCl₂ are added to the wastewater. The reactor comprises 100 g of catalyst and is irradiated with an 18 W black light lamp (λ=365 nm). After 6 h, 15.00% of the original amount of isobutyl chloride has degraded, after 24 h 24.00% of the original amount of isobutyl chloride has degraded.

The amounts of isobutyl chloride are determined in each case by means of gas chromatography in accordance with the headspace-sampling method.

1-12. (canceled)

13. A process for the purification of a contaminant-containing stream which comprises bringing the stream to be purified into contact with a heterogeneous TiO₂-photocatalyst with irradiation with light, wherein the bringing into contact takes place in the presence of at least one compound dissolved in the stream to be purified and comprising at least one metal selected from the group consisting of iron, chromium, nickel, cobalt, manganese and mixtures thereof, wherein the TiO₂-photocatalyst comprises at least one additive selected from the groups 1, 4, 8, 9, 10, 11, 13, 14, 15 of the periodic table of the elements or of the lanthanoids.

14. The process according to claim 13, wherein the process is carried out at a temperature of from 4 to 80° C.

15. The process according to claim 13, wherein the at least one compound dissolved in the stream to be purified and comprising at least one metal selected from the group consisting of iron, chromium, nickel, cobalt, manganese and mixtures thereof is present in an amount of from 10 to 1000 ppm, based on the sum of stream to be purified and the at least one compound dissolved in the stream.

16. The process according to claim 13, wherein the heterogeneous TiO₂-photocatalyst is present as strands, tablets, honeycomb lattice structures, powders, nanoparticles, coatings or combinations thereof.

17. The process according to claim 13, wherein titanium dioxide is used which is essentially present in the anatase modification.

18. The process according to claim 13, wherein the at least one compound dissolved in the stream to be purified is iron(II) chloride, iron(III) chloride or a mixture thereof.

19. The process according to claim 13, wherein the stream to be purified is a liquid stream.

20. A method of purifying a contaminant-containing stream which comprises contacting in the stream to be purified, a heterogeneous TiO₂-photocatalyst and at least one compound comprising at least one metal selected from the group consisting of iron, chromium, nickel, cobalt, manganese and mixtures thereof is present in dissolved form, wherein the TiO₂-photocatalyst comprises at least one additive selected from the groups 1, 4, 8, 9, 10, 11, 13, 14, 15 of the periodic table of the elements or of the lanthanoids.

21. The method according to claim 20, wherein the at least one compound dissolved in the stream to be purified and comprising at least one metal selected from the group consisting of iron, chromium, nickel, cobalt, manganese and mixtures thereof is present in an amount of from 10 to 1000 ppm, based on the sum of stream to be purified and the at least one compound dissolved in the stream.
